(19) United States
(12) Patent Application Publication
(10) Pub. No.: US 2016/0239766 A1
(43) Pub. Date: Aug. 18, 2016

(54) SYSTEMS, METHODS, AND USER INTERFACES FOR EVALUATING QUALITY, HEALTH, SAFETY, AND ENVIRONMENT DATA

(71) Applicant: Nathan R. Cameron, Cleveland, OH (US)

(72) Inventor: Nathan R. Cameron, Cleveland, OH (US)

(21) Appl. No.: 15/067,621

(22) Filed: Mar. 11, 2016

Related U.S. Application Data
(63) Continuation-in-part of application No. 14/622,924, filed on Feb. 16, 2015.

(51) Int. Cl. G06Q 10/06; G06F 3/0484

(52) U.S. Cl. CPC G06Q 10/063; G06F 3/04847

(57) ABSTRACT

According to the present disclosure, a method for evaluating Quality, Health, Safety, and Environment (QHSE) data can include providing a user interface. A preferred group of analysis algorithms can be identified, automatically with the one or more processors, from a set of analysis algorithms based upon category selections. The QHSE data can be analyzed, automatically with the one or more processors, with the preferred group of analysis algorithms. Posterior testing can be performed, automatically with the one or more processors, on each of the preferred group of analysis algorithms. A validation object can be provided and can selectively provide results of the posterior testing indicative of a fit between the QHSE data and one of the preferred group of analysis algorithms.

### CROSS-REFERENCE TO RELATED APPLICATIONS

This application is a continuation-in-part of U.S. patent application Ser. No. 14/622,924, filed Feb. 16, 2015.

### BACKGROUND

The present specification generally relates to systems, methods, and user interfaces for evaluating Quality, Health, Safety, and Environment (QHSE) data and, more specifically, to systems, methods, and user interfaces for evaluating QHSE data and to identify improvements to QHSE processes and operations.

Unless otherwise indicated herein, the materials described in this section are not prior art to the claims in this application and are not admitted to be prior art by inclusion in this section.

There is increasing importance on the simultaneous need for the health and safety of employees, the quality of goods and services produced, and the protection, conservation, and reclamation of local communities and the natural environment. Currently a major deficiency exists for a system to fully integrate QHSE data from multiple, distinct resources and provide predictive improvement models. Companies and public entities are looking for ways to innovate and integrate QHSE processes so that they can improve margins and financial welfare, gain predictive insights from consumers, reduce costs, improve workplace morale, mitigate risks, enforce regulatory compliance, and improve company profile appearances as leaders in sustainable practices. Although QHSE processes are important and applicable in many industries, the QHSE processes are of relative importance to entities that deal with natural resource exploration, extraction, and processing. Extraction of natural resources can cause quality, health, safety, and environmental degradation whose costs are not internalized by the producing firm, creating negative externalities. Negative externalities can impose undesired costs on taxpayers, local communities, producing entities, and regulatory agents. Examples within the natural resources industry can include leaching, tailings, aesthetic damage, air pollution, and water pollution.

The ability to define, quantify, analyze, and interpret QHSE costs and benefits can be pragmatic for creating synergies between extraction industries, manufactures, suppliers, government entities, communities, and the natural environment. Different company data systems, wide-ranging statistical analysis techniques, and varying process improvement methodologies further complicate ways to address QHSE management causing unnecessary risks and delays due to the complexities in QHSE operations and processes. QHSE systems need to be robust, flexible, and fully integrated into the existing processes and operations, in order to improve return on investment, and reduce negative consequences from externalities, or both.

Accordingly, a need exists for alternative systems, methods, and user interfaces for evaluating, analyzing, interpreting, or visualizing QHSE data.

### SUMMARY

In one embodiment, computer based program, coding, and algorithms can be used as a standalone or integrated module for local, network, cloud, and mobile systems. These modules can include: data acquisition, data aggregation, data formatting, data categorization, data isolation, algorithm selection processes, Bayesian statistical and econometric analysis, Frequentist methodologies, Mixed Method approaches, posterior testing, sensitivity analysis, the continuous improvement matrix, data dashboard outputs, and data export options.

In another embodiment, user data can be acquired from one or more distinct quality, health, safety, and environmental sources. Once the data is acquired, the data can be aggregated and compiled through a processing algorithm and stored in a computer, server, or cloud storage medium. This compiled data can then be formatted in rows and columns easily accessible through commonly used database and spreadsheet software programs. The data can be categorized into various qualitative and/or quantitative bins. The categorized data can then be isolated through the use of a series of sorting algorithms that provides statistically viable data of particular interest to the user. The isolated data of significant variables can be confirmed by the user. The confirmed data can then be processed through the analysis engine.

In another embodiment, an iterative methodology of the analysis can be applied to QHSE operations. Iterative selected tests and analyses can be based upon automated processes and defined criteria to detect patterns in significant variables of the dataset. Bayesian, Frequentist, and Mixed Method approaches to the data can provide a dynamic, flexible assessment of existing conditions and probabilistic outcomes. The significant variables can then undergo a robust posterior and specification analysis to ensure proper testing procedures and analyses were selected. If posterior tests are not acceptable, the resultant data can be recycled through the iterative data analysis steps. The process can be repeated until the data analysis based on user criteria is acceptable. Additionally, sensitivity analysis can be performed on the significant variables to determine the impact of incremental changes in variables. The completed analysis can be confirmed by a user and placed into a continuous improvement matrix.

In another embodiment, a continuous improvement matrix can use significant variables from the analysis engine results for row and column header inputs. The resultant data can show conflicts between the variable such as, for example, air pollution increases v. production efficiency increases, or rate of production v. safety of employees. Poor management of significant variables can lead to stalemates and delays in improving QHSE operations. The variables can be analyzed in the continuous improvement matrix format with a series of innovative ideologies. Innovative ideologies can be used to create a solution key with strategies to continuously improve upon existing QHSE operations, while specifically addressing potential conflicts.

In another embodiment, a computer implemented method for evaluating Quality, Health, Safety, and Environment (QHSE) data can include providing a user interface upon a display communicatively coupled to one or more processors. Category selections can be received with a plurality of category controls of the user interface. The category selections can categorize the QHSE data. A preferred group of analysis algorithms can be identified, automatically with the one or more processors, from a set of analysis algorithms based upon the category selections. The QHSE data can be analyzed, automatically with the one or more processors, with each of the preferred group of analysis algorithms. Posterior testing can be performed, automatically with the one or more processors, on each of the preferred group of analysis algorithms. A validation object can be provided, automatically with the one or more processors, for each of the preferred group of analysis algorithms with the user interface. The validation object can selectively provide results of the posterior testing indicative of a fit between the QHSE data and one of the preferred group of analysis algorithms.

In another embodiment, a computer implemented method for evaluating Quality, Health, Safety, and Environment (QHSE) data can include providing a user interface upon a display communicatively coupled to one or more processors. The QHSE data can be analyzed, automatically with the one or more processors, with a plurality of analysis algorithms. A sensitivity analysis object can be provided, automatically with the one or more processors, for each of the analysis algorithms with the user interface. The sensitivity object can include a summary object that displays results of a corresponding analysis algorithm of the analysis algorithms and a parameter adjustment control. A parameter change can be received with the parameter adjustment control. The results of the corresponding analysis algorithm and the summary object can be updated, automatically with the one or more processors, in response to the parameter change. The results of the corresponding analysis algorithm can be imported into a continuous improvement matrix of the user interface. The continuous improvement matrix can visually depict a solution key that scores similarity of variables of significance of the results of the corresponding algorithm with respect to an innovative ideology.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an overview of a system for interacting with an analysis engine according to one or more embodiments shown and described herein;

FIG. 2 schematically depicts a method for evaluating QHSE data according to one or more embodiments shown and described herein;

FIG. 3 schematically depicts categorization of QHSE data according to one or more embodiments shown and described herein;

FIGS. 4 and 5 schematically depict a user interface according to one or more embodiments shown and described herein;

FIG. 6 schematically depicts a set of algorithms according to one or more embodiments shown and described herein; and

FIGS. 7-10 schematically depict a user interface according to one or more embodiments shown and described herein.

### DETAILED DESCRIPTION

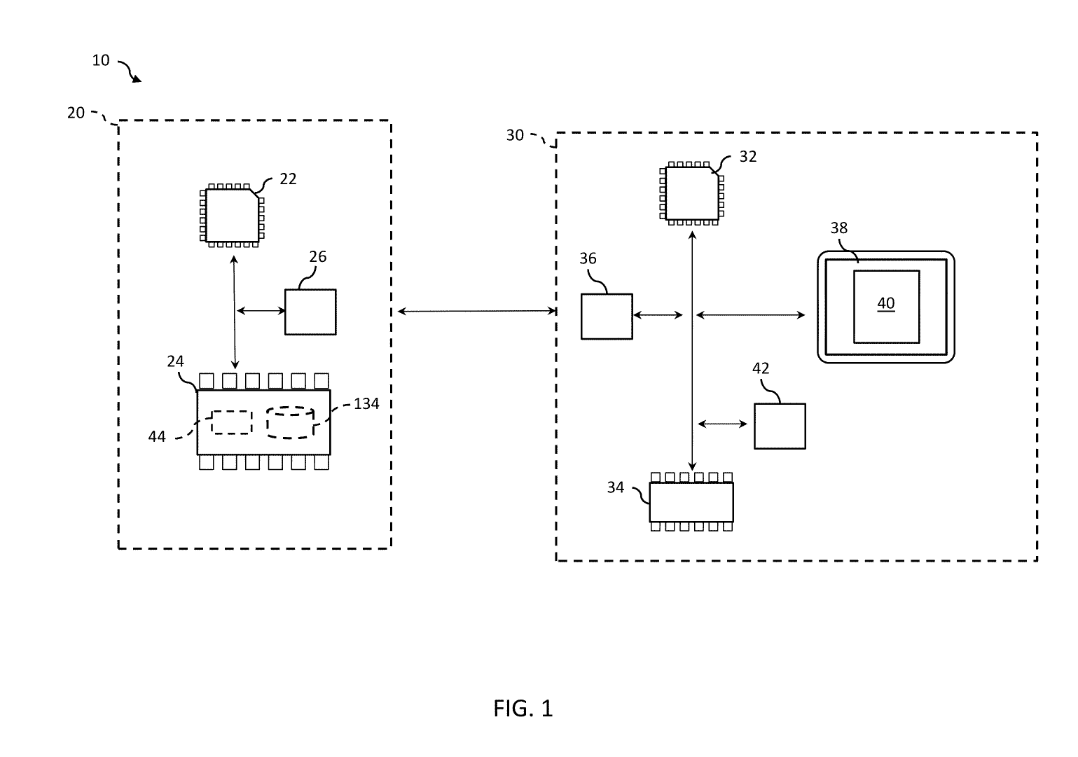

FIG. 1 generally depicts one embodiment of a system for providing interaction with an analysis engine. The analysis engine can be configured to evaluate Quality, Health, Safety, and Environment (QHSE) operations. In some embodiments, systems and methods can provide an interface for analysis, pattern detection, predictive modeling, and continuous improvement of QHSE operations via the analysis engine, continuous improvement matrix, or both. Accordingly, the present disclosure relates to systems and methods that can be used to expose synergistic relations of QHSE operations. Once exposed, the synergistic relations of QHSE operations can be used by commercial and public entities to increase production, increase their public profile, reduce costs, mitigate health and safety costs, and exceed regulatory expectations. Various embodiments of the system and the operation of the system will be described in more detail herein. As is described in greater detail herein, iterative methods and user interfaces that can be used for analysis, pattern detection, predictive modeling, and continuous improvement of QHSE operations.

Referring now to FIG. 1, a system 10 for evaluating QHSE data is schematically depicted. The system 10 can comprise an analysis engine server 20 that is communicatively coupled to an analysis client 30 (generally depicted as double arrowed lines). As used herein, the phrase “communicatively coupled” can mean that components are capable of exchanging data signals with one another such as, for example, electrical signals via conductive medium, electromagnetic signals via air, optical signals via optical waveguides, and the like. It is furthermore noted that the term “signal,” as used herein, can mean a waveform (e.g., electrical, optical, magnetic, or electromagnetic), such as DC, AC, sinusoidal-wave, triangular-wave, square-wave, and the like, capable of traveling through a medium.

In some embodiments, the monitoring server 20 can comprise one or more processors 22 for executing machine readable instructions to perform functions according to the methods described herein. As used herein, the term “processor” can mean any device capable of executing machine readable instructions. Accordingly, each processor can be a controller, an integrated circuit, a microchip, or any other device capable of implementing logic.

The one or more processors 22 can be communicatively coupled to memory 24. As used herein, the term “memory” can mean any device capable of storing machine readable instructions. Accordingly, “memory,” as described herein, can comprise RAM, ROM, a flash memory, a hard drive, or any other non-transitory device capable of storing machine readable instructions. Additionally, it is noted that the software, functions, modules, and processes described herein can be provided as machine readable instructions stored on memory 24 and executed by the one or more processors 22. The machine readable instructions can be provided in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on a machine readable medium. Alternatively, the functions, modules, and processes described herein may be written in a hardware description language (HDL), such as logic implemented via either a field-programmable gate array (FPGA) configuration or an application-specific integrated circuit (ASIC), and their equivalents. Accordingly, the functions, modules, and processes described herein may be implemented in any conventional computer programming language, as pre-programmed hardware elements, or as a combination of hardware and software components.

Referring still to FIG. 1, the analysis engine server 20 can comprise network communication hardware 26 communicatively coupled to the one or more processors 22. The network communication hardware 26 can be configured to communicatively couple the analysis engine server 20 to the analysis client 30, such as for example via the internet. The network communication hardware 26 can comprise hardware configured for network communication such as, for example, a wide area network, a local area network, a personal area network, a global positioning system and combinations thereof. Accordingly, the network communication hardware 26 can be configured to communicate, i.e., send and/or receive data signals via any wired or wireless communication protocol. For example, the network communication hardware 26 can comprise an antenna, a modem, LAN port, wireless fidelity (Wi-Fi) card, WiMax card, near-field communication hardware, satellite communication hardware, or the like. Accordingly, the analysis engine server 20 can be communicatively coupled to other devices via wires, via a wide area network, via a local area network, via a personal area network, via a satellite network, or the like. For example, the analysis engine server 20 can be provided as a cloud computing device that can exchange data signals with the analysis client 30 via the internet. Suitable local area networks can comprise wired ethernet and/or wireless technologies such as, for example, Wi-Fi. Suitable personal area networks can comprise wireless technologies such as, for example, IrDA, BLUETOOTH, Wireless USB, Z-WAVE, ZIGBEE, or the like. Alternatively or additionally, suitable personal area networks may include wired computer buses such as, for example, USB and FIREWIRE.

In some embodiments, the one or more processors 22 can execute web server software provided as machine readable instructions such as, but not limited to, via storage on memory 24. Suitable web server software includes, but is not limited to, Apache HTTP Server, Internet Information Services, Nginx, Google Web Server, or the like. Accordingly, the analysis engine server 20 can utilize a server operating system such as, for example, UNIX, Linux, BSD, Microsoft Windows, or the like.

Referring still to FIG. 1, the analysis client 30 can comprise one or more processors 32 for executing machine readable instructions to perform functions according to the methods described herein. The analysis client 30 can comprise memory 34 communicatively coupled to the one or more processors 32. The one or more processors 32 can also be communicatively coupled to network communication hardware 36, which can be configured like the network communication hardware 26 described above. Accordingly, the analysis engine server 20 and the analysis client 30 can communicate (e.g., send, receive, or both) data signals via the network communication hardware 26 and the network communication hardware 36. Various machines can be utilized as the analysis client 30 without departing from the scope of the embodiments described herein such as, for example, a smart phone, a tablet, a laptop computer, desktop computer, a server, or a specialized machine having communication capability. It is noted that, while FIG. 1 depicts a server-client arrangement, the system 10 can be implemented using a stand-alone machine that is configured to perform the functions of both the analysis engine server 20 and the analysis client 30.

The analysis client 30 can comprise a display 38 communicatively coupled to the one or more processors 32 for providing a user interface 40 via the transmission of optical signals. In some embodiments, the display 38 can comprise a plurality of pixels that can decode a signal provided by the one or more processors 32 to selectively illuminate pixels to provide the user interface 40. The display 38 can comprise light emitting diodes (LED or OLED), liquid crystal display (LCD), liquid crystal on silicon (LCOS), or the like.

The analysis client 30 can comprise an input device 42 for sensing user input and encoding the input into a signal indicative of the user input. Suitable examples of the input device 42 include a keyboard, a mouse, a camera, a microphone, or the like. In some embodiments, the input device 42 can be configured to operate as a touch screen for accepting input via visual controls or objects. Accordingly, the display 38 can comprise an input device 42 configured as a touch detector such as, for example, a resistive sensor, capacitive sensor, or the like.

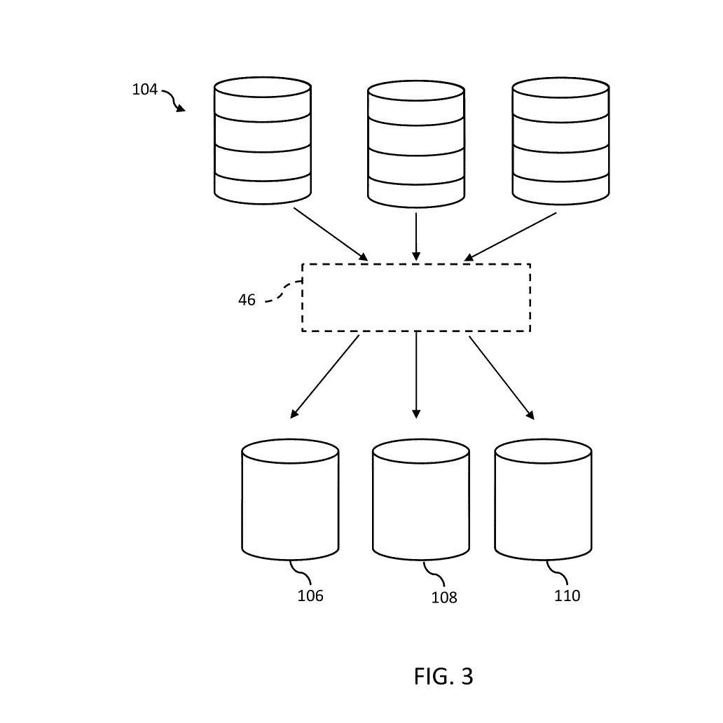

Referring collectively to FIGS. 1, 2, and 3, the embodiments provided herein can comprise a method 100 for evaluating QHSE data 104 with an analysis engine 44. The method 100 can comprise a process 102 for uploading data. In some embodiments, the data can comprise QHSE data 104. The QHSE data 104 can comprise, for example, historical data, engineering control data (e.g., from sensors), OSHA related inquiries, ecosystem data collection (e.g., species mix, plant life, climate factors, input production mixes, output production mixes, operational measures, time measurements), and the like. The QHSE data 104 can be provided from one or more internal sources and departments such as, for example, manufacturing lines, field service crews, monitoring devices, QHSE Audits, human resources, accounting, marketing, sales, and high-level management. Alternatively or additionally, the QHSE data 104 can be provided from external data sources such as, for example, competitive benchmarking, geophysical sources, ecological sources, macro-economic data, government research projects, eye witnesses, laws, and regulations. Accordingly, the QHSE data 104 can be acquired from one or more users of different backgrounds. As a result, the embodiments described herein can facilitate cross-disciplinary analysis.

At process 102, the user interface 40 can be provided upon the display 38. The user interface 40 can provide multiple dataset upload options. For example, the user interface 40 can provide browse functionality for accessing QHSE data 104 in memory 34 and uploading or linking the QHSE data 104 to the analysis engine 44. In some embodiments, the QHSE data 104 can be provided in a relational format such as, for example, spreadsheet data, database data, or any format suitable to organize the data for use with spreadsheet or database programs. Specifically, in one embodiment of the data, the QHSE data 104 can be organized in a table such that variables are stored in columns, and a row represents an instance of each of the variables. It is noted that, while the QHSE data 104 is described herein with respect to a particular tabular organization of rows and columns, the QHSE data 104 can be organized in any relational matter without departing from the scope of the present disclosure.

In some embodiments, the user interface 40 can provide industry specific templates. The QHSE data 104 can be input into one or more of the templates, which can be configured to format data for use with the analysis engine 44. Alternatively or additionally, the user interface 40 can comprise a data format link that can be configured to access and display information lexicons. Suitable information lexicons include information derived from American National Standards Institute (ANSI) SQL standards such as, for example, definitions, acronyms, or any typical variations shown in spreadsheet and database programs.

Referring still to FIGS. 1, 2, and 3, once the QHSE data 104 is uploaded and/or linked, a sorting algorithm 46 can be executed to sort the QHSE data 104 into a plurality of categories based on the initial source properties and metadata of the QHSE data 104. Specifically, the plurality of categories can comprise quantitative data 106, qualitative data 108, and descriptor data 110. The quantitative data 106 can be data indicative of counted or measured attribute of an item of interest. The quantitative data 106 can correspond to data instances having all numeric characters 0-9, “+” or “−” signs, a “.” for decimals, or an “e” for scientific notation. The quantitative data 106 can take the form of ordinal data, interval data, ratio data, or the like. Examples of the quantitative data 106 can include, but are not limited to, area values of extraction project, amount of oil, amount of minerals or natural gas, volume of contaminants, pressure readings, OSHA Incidents Rates, temperature, velocity, or the like. Accordingly, the quantitative data 106 can comprise units that are descriptive of data instances such as, for example, m, cm, mm, km, in, lbs, mi, bbl, mcf, or the like.

The qualitative data 108 can be data that characterizes attributes of the item of interest, but does not quantitatively measure attributes of the item of interest. For example, the qualitative data 108 can characterize interpretations of observed scenarios, predictions of future behavior, employee motivations, perceptions of view sheds, and NIMBY (Not in my Backyard) environmental parameters. Example sources of the qualitative data 108 can include, but are not limited to, surveys (e.g., emotional or demographic survey datasets concerning preservation and conservation), transcripts, audio, video, interviews, images, meeting minutes, focus groups, case studies, or other descriptive documents. Focus groups can provide dynamic feedback and specific details on how process and operational improvements are having effect on the overall QHSE of an entity. Employees of geographically and socially diverse backgrounds can provide insight into what their perceptions, feelings, and opinions are about a project. Case studies can provide insight in evaluating existing programs, benchmarking competitive processes, and develop recommendations for future actions. Accordingly, multiple facets of an issue can be discovered and analyzed.

The qualitative data 108 can correspond to data instances having any alpha-numeric combinations, which can include special characters that are not reserved in common database programs. Specific examples of the character data instances include, but are not limited to, tall, short, old, large, small, medium, high, low, good, bad, gender, race, socioeconomic categories, religious preferences, or the like. The descriptor data 110 can correspond to data instances that identify the variables such as, for example, column headers and labels. The descriptor data 100 can comprise any alpha-numeric combination, including special characters that are not reserved. Generally, the descriptor data 100 can be found in the first row of the QHSE data 104. In embodiments where the QHSE data 104 is provided in .csv, .xlsx, or .xls format, the data instances can be aligned right in a column by default.

In some embodiments, the sorting algorithm 46 can be configured to evaluate each of the variables and categorize the QHSE data 104 as quantitative data 106, qualitative data 108, or descriptor data 110. For example, the sorting algorithm 46 can use an if/then statement to loop through the QHSE data 104 and address each variable (e.g., column) of the QHSE data 104. The sorting and categorization of the QHSE data 104 can direct subsequent analysis by the analysis engine 44. Accordingly, processing of the QHSE data 104 can be more efficient and robust by aligning proper categories and formatting to analysis algorithms. For example, a mismatch between data and analysis algorithm can be avoided, i.e., running an OLS or dynamic optimization series of equations on qualitative data 108 or descriptor data 110 can result in critical errors and failures.

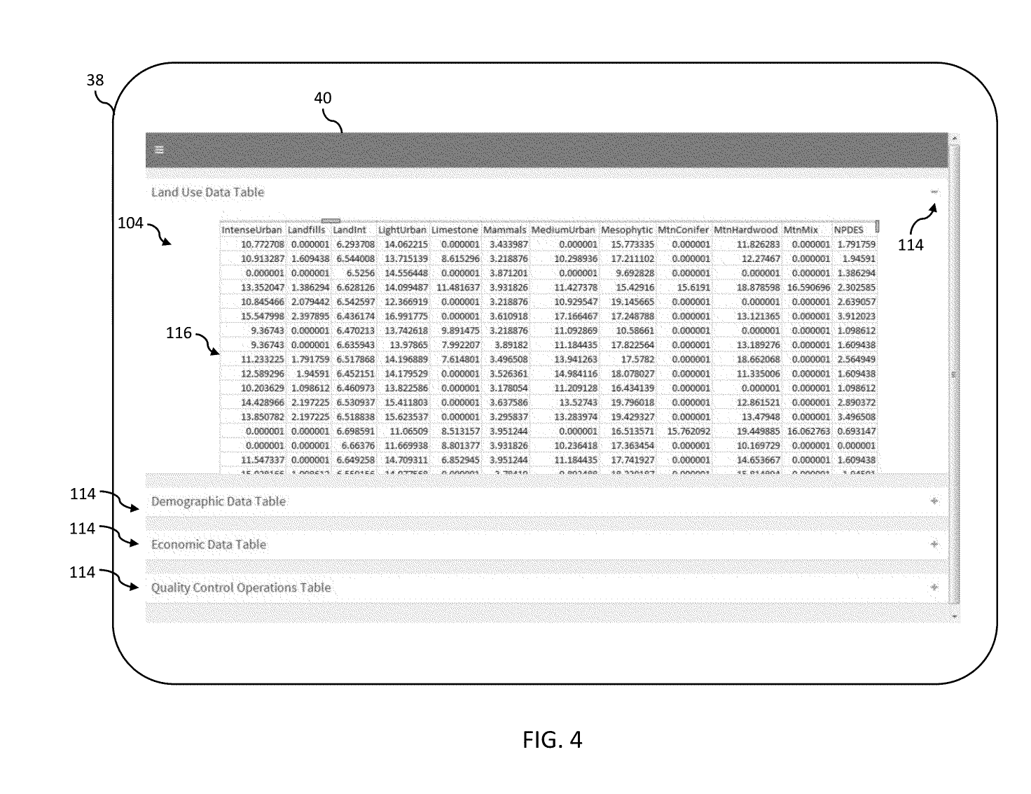

Referring collectively to FIGS. 1, 2, 3, and 4, the method 100 can comprise a process 112 for previewing data. In some embodiments, the QHSE data 104 can comprise a plurality of datasets. Accordingly, the datasets can correspond to the QHSE data 104 uploaded during process 102. Alternatively or additionally, the datasets can correspond to QHSE data 104 provided as pre-uploaded template datasets, or previously uploaded QHSE data 104. In some embodiments, the user interface 40 can be configured to provide a preview of the loaded data sets. For example, the user interface 40 can comprise one or more dataset preview controls 114 that are configured to provide a preview of an associated dataset. For example, in response to user input provided by the input device 42 indicative that is of a selection of the dataset preview controls 114, a corresponding dataset can be provided via the user interface 40.

The selected dataset of the QHSE data 104 can be provided as a table 116 having columns corresponding to variables and rows corresponding to instances of the variables. In some embodiments, the table 116 can present a subset of the instances of the variables, i.e., less than all of the rows of data can be presented. Alternatively or additionally, the user interface 40 can be configured to provide visual indicia indicative of the category corresponding the variable of the table. For example, the header of each column can be color coded to indicate the category of the variable. Specifically, each of the quantitative data 106, the qualitative data 108, and the descriptor data 110 can correspond to a different color code that can be applied to indicate the category. Accordingly, the table 116 can be reviewed to search for discrepancies between the instances of data and the categories.

In some embodiments, the table 116 can be configured to respond to user input. For example, a control can be associated with one or more cells of the variable such as, for example, the header. In response to user input provided by the input device 42 indicative of a selection of the control, the user interface 40 can provide a control for receiving input to change the category of the variable. For example, if the visual indicia corresponds to an incorrect category for a variable, the corresponding column can be selected and the category can be changed. In embodiments having multiple datasets, the dataset preview controls 114 of the user interface 40 can be selected to switch between dataset previews. Alternatively or additionally, the user interface 40 can be configured to allow movement of variables between datasets. For example, a column of the table 116 can be dragged and dropped to another dataset. Such action can merge the variable into the data set in a manner analogous to a “JOINS” SQL command. Alternatively or additionally, such action can remove the variable from the selected dataset.

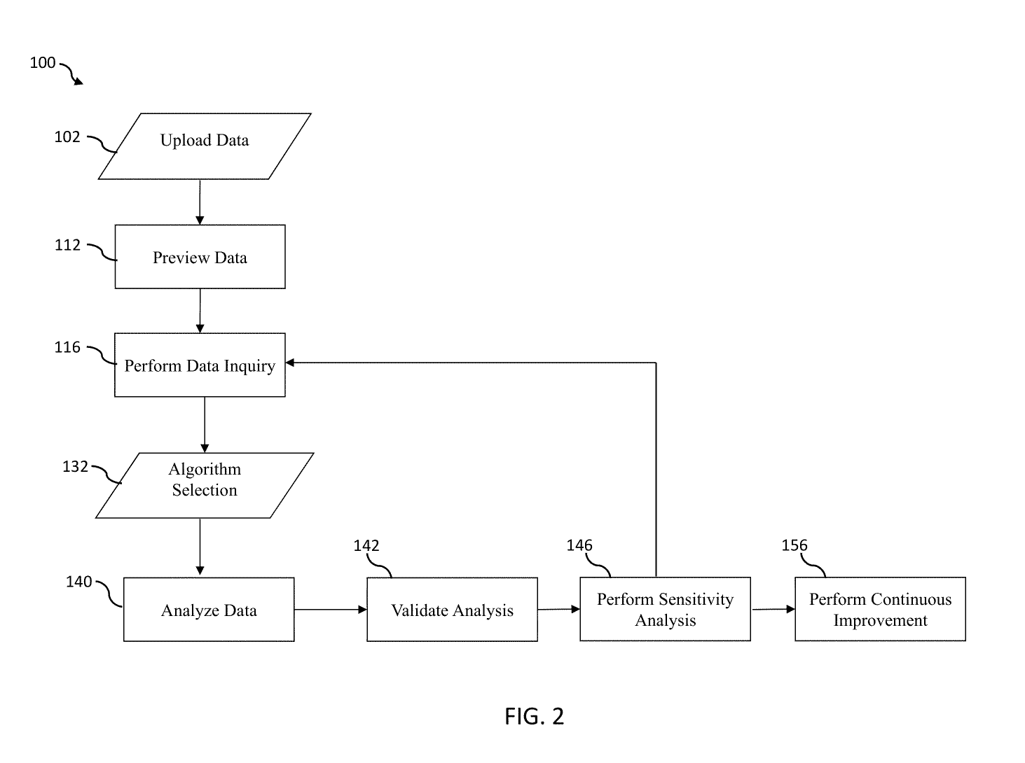

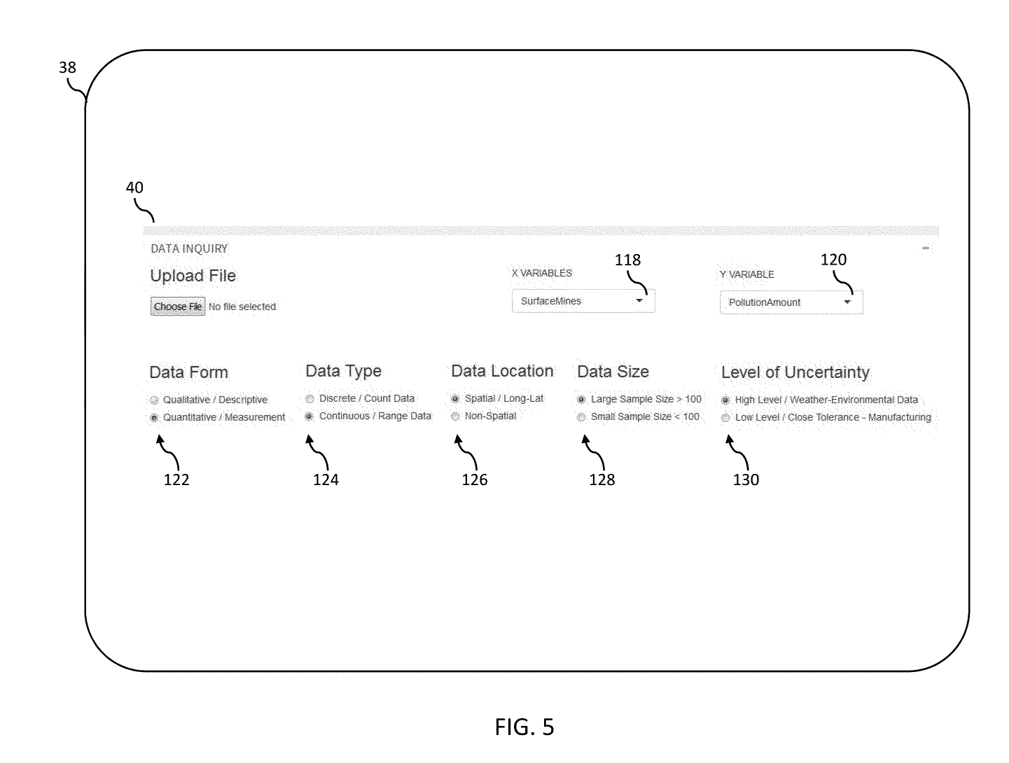

Referring collectively to FIGS. 2, 3, and 5, the method 100 can comprise a process 116 for performing data inquiries. The datasets of the QHSE data 104 can be processed by one or more aggregation and formatting tests. In some embodiments, the aggregation and formatting tests can be performed after the categorization of process 102. The one or more aggregation and formatting tests can include, but are not limited to, normalization, parsing, clustering, dependency, dimensionality algorithms, or the like. It is noted that the QHSE data 104 can be provided in relational format after the aggregation and formatting tests are performed. Accordingly, the aggregated and formatted data sets of the QHSE data 104 can be converted into a table having rows and columns, as described above. According to some embodiments, the aggregation and formatting tests can be selected by a user via the user interface 40. Thus, the data sets of the QHSE data 104 can be screened based upon user preferences and potential improvement solutions.

At process 116, the datasets of the QHSE data 104 can be categorized based upon the predominant variable categorization from process 102, the one or more aggregation and formatting tests, or both. In some embodiments, the user interface 40 can be configured to receive input to adjust the categorization for variables of the QHSE data 104. The user interface 40 can comprise one or more variable controls 118 for selecting variables from a data set of the QHSE data 104. For example, the one or more variable controls 118 can be configured to display the descriptor data 110 associated with a plurality of instances of the variable. The user interface 40 can further comprise a dependent variable control 120 for selecting variables from a data set of the QHSE data 104, in a manner analogous to the one or more variable controls 118. Generally, the variable identified by the dependent variable control 120 can be considered to be a function of the one or more variables identified by the one or more variable controls 118.

Each of the variables can be provided with a default categorization, automatically. Specifically, each of the variables can be associated with one or more categories. Accordingly, the user interface 40 can comprise a plurality of category controls configured to display the current category associated with the variable and to provide one or more alternative categories for selection. In some embodiments, each of the category controls can be configured receive user input to verify the default category or choose an alternative category for the variable. Initially, each of the category controls can be populated to indicate the default categorization, i.e., according to the automatically determined category.

The user interface 40 can comprise a first category control 122 configured to select a data form category that identifies the variable as being associated with quantitative data 106 or qualitative data 108. The first category control 122 can also be configured to associate the variable with particular algorithms according to the current category selection. For example, the first category control 122 can associate variables that are identified as being associated with quantitative data 106 with algorithms that apply mathematical operations to the data. Suitable algorithms include, but are not limited to, Frequentist methodologies, Bayesian methodologies, Decision/Game Theory methodologies, regression models, Ordinary Least Squares (OLS), Non-Linear, Dynamic Optimization, Time Series Data, Neural Networks, Machine Learning, Spatial Econometric Analysis, Logits, Probits, or the like. Frequentist methodologies can include algorithms that utilize traditional hypothesis testing, frequencies and proportional data, averages, confidence intervals, R² values, distribution test statistics, or other frequentist statistics. Frequentist statistics can estimate unknown parameters of variable relationships and tests their statistical significance. The testing methodology can include sampling, simplifying assumptions, experimental design, parameter estimations, and various regression analyses. Frequentist statistics can be for repeatable experiments that can be designed controlled for a null hypothesis such as, for example, factory, manufacturing, and lab settings where high levels of control are present.

Bayesian methodologies can be based on historical prior data distribution, likelihood functions, and posterior distribution. Bayesian testing methodologies can be used to analyze dynamic optimization outcomes and handle datasets with large amounts of inherent uncertainties. These uncertainties can be in QHSE data 104 where variability can be location based, weather related, and disturbance related. Additionally, complex ecological-social-economical phenomenon can be iteratively and adaptively managed through Bayesian methodologies, as is described in greater detail below. Decision/Game Theory methodologies can be used for strategic decision making. Decision/Game Theory algorithms can evaluate the participating entities, possible choices, sequences of events, and uncertainties, where data and actions of one entity influence and change subsequent data from other sources. The algorithms can evaluate conflicting and cooperative interactions between entities and analyze desired solutions based on criteria of interest. The algorithms can be used to continuously improve upon QHSE processes with large amounts of existing data, external competition, and regulatory uncertainty.

The first category control 122 can associate variables that are identified as being associated with qualitative data 108 with algorithms that evaluate the significance of characterized attributes. Suitable algorithms include, but are not limited to, Ranking methodologies, Cluster Analysis, Principal Component Analysis (PCA), Multiple Criteria Decision Models (MCDM), Decision Trees, Linear Discriminate Analysis (LDA), Contigent Valuation methodologies, or the like. Ranking methodologies can employ numerical rankings, ordinal rankings, or more complex evaluations such as, for example, Friedman Testing, AHP variations, Kruskall Wallis Testing, Rank Sum, Spearman, Bootstrapping variations, Wilcoxon, or the like. It is furthermore noted that the embodiments described herein can comprise mixed method testing algorithms. Mixed method testing algorithms can merge the data identified as quantitative data 106 and qualitative data 108. Mixed method testing algorithms can provide an equal and unequal merge as to what type of data is given priority over another. Mixed method testing algorithms can evaluate significant variables from different perspectives, which can be used to combine the quantitative nature of manufacturing and ecological phenomena with qualitative aspects of social data.

Referring still to FIGS. 2, 3, and 5, the plurality of category controls of the user interface 40 can comprise a second category control 124 configured to select a data type category that identifies the variable as being discrete data or continuous data. The discrete data can correspond to count based information, i.e. data having only finite possible values. In other words, the values from the dataset cannot be divided. Examples of discrete data can include, but are not limited to, number of employees, number of accidents, number of plant and animal species, number of wellheads, or the like. Additionally, a discrete variable can be created from qualitative data by “counting” the instances of an observation to encode the observation as a discrete value. Observations can include the number of severe casualties that occur during an exploration or at a production site. Another example can include a survival analysis using data indicative of employees engaged in certain activities in a mine before an injury occurs. Characterizations of observed injuries can be translated into count data. Alternatively or additionally, bivariate discrete data can be encoded in numeric form (e.g., 1 or 0) such as, for example, by encoding a first observation with a first number and encoding a second observation with a second number during a time of interest. Specifically, an observation of an event can be encoded with a “1” and a non-event can be encoded with a “0.” Continuous data can correspond to data having any value within a given range, which can be infinitely subdivided into smaller measurements. For example continuous data can include values between 0 and 1 such as, for example, 0.03, 0.03145, 0.031452378, and so on. Examples of continuous data can include, but are not limited to, temperature, mass, velocities, pressures, volumes, or the like.

The second category control 124 can also be configured to associate the variable with particular algorithms according to the current category selection. For example, the second category control 124 can associate variables that are identified as being associated with discrete data with algorithms that apply operations or statistical distributions suitable for use with discrete data. Suitable discrete distributions include, but are not limited to, binomial, Poisson, multinomial, pascal, or the like. The second category control 124 can associate variables that are identified as being associated with continuous data with algorithms that apply operations or statistical distributions suitable for use with continuous data. Suitable continuous distributions can include, but are not limited to, Normal, Log, Weibull, Exponential, or the like. Suitable continuous operations include, but are not limited to, regressions (e.g., linear, polynomial, log, stepwise, and spatial), analysis of variance (ANOVA), spatial econometrics, simulations, or the like.

According to the embodiments described herein, the plurality of category controls of the user interface 40 can comprise a third category control 126 configured to select a data location category that identifies the variable as being spatial data or non-spatial data. The spatial data can correspond to data arranged in a topological, a geometric, or a geographically significant manner. Spatial data can be mapped based upon the specificity of location information within the dataset. Observations of spatial data relate to a reference datum, latitude and longitude coordinates, or a general scale (e.g., zip code, voter districts, or states). The scale of spatial data can be as small as component arrangements on a microprocessor, or as large as international distribution networks. Further examples of spatial data can include, but are not limited to, employee distribution within a plant, a mine within the context of the regional landscape, placement of equipment within a site, financial profitability per spatially significant region, or the like. Non-spatial data can correspond to substantially spatially independent datasets. The substantially spatially independent datasets can include observations that are spatially independent (i.e., randomly placed), observations that are not associated with spatial information in the dataset, or observations that are associated with non-relevant spatial information. For example, spatial information may not be relevant when the observing items produced in one location, on the same assembly line, and under the same conditions.

The third category control 126 can also be configured to associate the variable with particular algorithms according to the current category selection. For example, the third category control 126 can associate variables that are identified as being associated with spatial data with algorithms that determine an amount of spatial influence between variables of the dataset. Suitable algorithms include, but are not limited to, spatial autoregressive models, spatial error models, spatial Durbin, or the like. Accordingly, before subsequent analysis is performed on spatial data (e.g., regression analysis), the spatial data can be evaluated to determine the amount of spatial influence between significant variables (spatial autoregressive models), identify undetermined random effects or errors (spatial error models), or both (spatial Durbin). When spatial effects are not considered projects can fail, have budgetary issues, cause human resource deficiencies such as insufficient personnel or overstaffing. Accordingly, the embodiments described herein can automatically identify model specifications, estimations, testing techniques, and posterior analysis algorithms based on variables being associated with spatial data. The third category control 126 can associate variables that are identified as being associated with non-spatial data with traditional Frequentist and Bayesian testing methodologies and algorithms.

Referring still to FIGS. 2, 3, and 5, the plurality of category controls of the user interface 40 can comprise a fourth category control 128 configured to select a data size category that identifies the variable according to the sample size. In some embodiments, the sample size can be identified as being a small sample size or a large sample size. For example, a predetermined number of samples can be utilized to establish the threshold between the small sample size and the large sample size. The predetermined number of samples can be any quantity suitable to impact subsequent analysis such as, for example, about 50 data points in one embodiment, or about 100 data points in another embodiment. The small sample size data can correspond to observations from, for example, new processes with no historical data, large scale projects that lack replication or similar project parameters, unique-niche market scenarios with limited benchmarking data, or the like. Additionally, the large sample size data can correspond to observations from, for example, national marketing data, advertising campaign data, real-time monitoring devices, multiple projects with easy replication, macro-economic data, complex ecological phenomena, or the like.

The fourth category control 128 can also be configured to associate the variable with particular algorithms according to the current category selection. For example, the fourth category control 128 can associate algorithms to variables that are identified as being associated with the small sample size with algorithms suitable for use with relatively small data sets. Suitable algorithms include, but are not limited to, bootstrapping methods of determining distribution of data, non-parametric methodologies, Small Sample T-Tests, F-Tests, Monte Carlo simulations, or the like. The fourth category control 128 can associate variables that are identified as being associated with the large sample size with algorithms that determine distribution types for subsequent algorithms and processes within the analysis engine. Additionally, variables associated with the large sample size can be evaluated to determine more precise confidence intervals. Moreover, variables associated with the large sample size can be evaluated with transformations and iterations of processing subsets of the data.

According to the embodiments described herein, the plurality of category controls of the user interface 40 can comprise a fifth category control 130 configured to select a data uncertainty category that identifies the variable as being low uncertainly data or high uncertainty data. The low uncertainty data can correspond to data having relatively low levels of uncertainty, risk, volatility, inconstancy, or unreliability. Generally, the low uncertainty data generates credible probabilistic outcomes with relatively narrow ranges. Low uncertainty data can be provided from observing manufacturing processes with tight tolerances. The high uncertainty data can correspond to data having relatively high levels of uncertainty, risk, volatility, inconstancy, or unreliability. Generally, the high uncertainty data generates credible probabilistic outcomes with relatively wide ranges. High uncertainty data can be provided from observing, for example, weather patterns, ecological phenomena, social-economic phenomena, global multi-product scenarios for manufacturing, or the like.

The fifth category control 130 can also be configured to associate the variable with particular algorithms according to the current category selection. For example, the fifth category control 130 can associate variables that are identified as being associated with low uncertainty data with algorithms that perform frequentist analysis or generate data based on different treatments or groups. Suitable algorithms can include, but are not limited to, traditional regressions, QA/QC approaches, traditional hypothesis testing, or the like. The QA/QC approaches can fit the data to a model via data transformations (e.g., logarithmic and exponential), and can include, but are not limited to, variances, standard deviations, Shewhart control charts, or the like. Traditional hypothesis testing can include, for example, Null v. Not Null testing, R values, Wald Tests, or other model verification statistics. The fifth category control 130 can associate variables that are identified as being associated with high uncertainty data with algorithms that perform Bayesian analysis. Accordingly, a model to can be fit to the data, rather than fitting data to the model. The high uncertainty data may not be adequately analyzed by traditional frequentist methodologies and transformations. The use of Bayesian analysis can allow a user to create iterative and adaptive measurements based upon the high uncertainty data.

Referring collectively to FIGS. 1, 2, 6, and 7, the method 100 can comprise a process 132 for selecting algorithms. In some embodiments, the analysis engine 44 can be configured to utilize any of a set of analysis algorithms 134 provided in memory 24. The set of analysis algorithms 134 can represent an inclusive and expanding set of all possible analysis algorithms that can be executed during execution of the analysis engine 44. Accordingly, the set of analysis algorithms 134 can comprise any of the analysis algorithms described herein. It is noted that, while the analysis engine 44 and analysis algorithms 134 are depicted in FIG. 1 as being provided on memory 24, in further embodiments the analysis engine 44 and analysis algorithms 134 can be provided on memory 34 to provide, for example, a single machine embodiment.

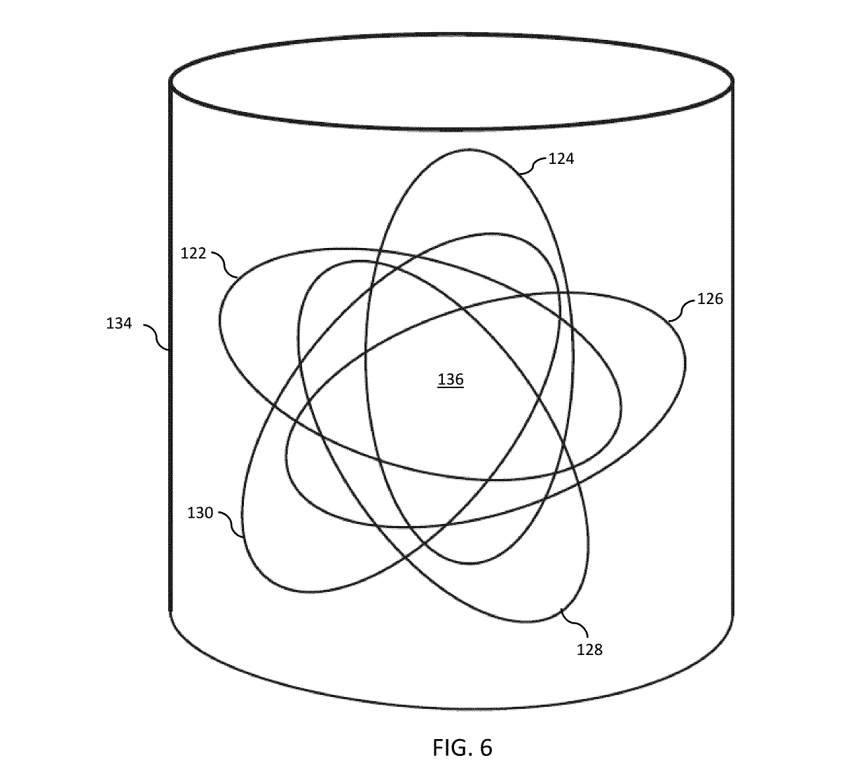

At process 132, a preferred group 136 of the set of analysis algorithms 134 can be identified. Specifically, the preferred group 136 can be a subset of the set of analysis algorithms 134 that are configured to analyze particular categories of data. For example, the preferred group 136 can be the algorithms associated with the dataset using the plurality of category controls. In some embodiments, each analysis algorithm of the set of analysis algorithms 134 can be associated with one or more tags that correspond to the input received by the plurality of category controls. In embodiments having five of category controls, the preferred group 136 can be identified by the overlap of the input received by the first category control 122, the second category control 124, the third category control 126, the fourth category control 128, and the fifth category control 130. Accordingly, each selection can associate the dataset with a subset of the set of analysis algorithms 134 and can eliminate undesired algorithms of the set of analysis algorithms 134. For example, the fifth category control 130 can identify the dataset as containing a high level of uncertainty. In response, algorithms not suited for high levels of uncertainty can be excluded, which is represented in FIG. 6 as the region unenclosed by the boundary identified as the fifth category control 130. The third category control 126 can identify the dataset as having locational/spatial significance. In response, analysis algorithms not suited for spatial data can be excluded. Further algorithms of the set of algorithms 134 can be excluded based upon selections received by the first category control 122, the second category control 124, and the fourth category control 128 (i.e., data form, data type and data size) to identify the preferred group 136, which is represented in FIG. 6 as the region enclosed by the intersection of the boundaries identified as the first category control 122, the second category control 124, the third category control 126, the fourth category control 128, and the fifth category control 130.

The user interface 40 can provide the preferred group 136 of the set of analysis algorithms 134 as test selection controls 138. For example, each of the test selection controls 138 can correspond to one of the algorithms of the preferred group 136. The preferred group 136 can be determined according to input that characterizes the dataset, i.e., the number and type of algorithms are selected automatically based upon the categorization of the data. Accordingly, the preferred group 136 can be determined by users without knowledge of the algorithms.

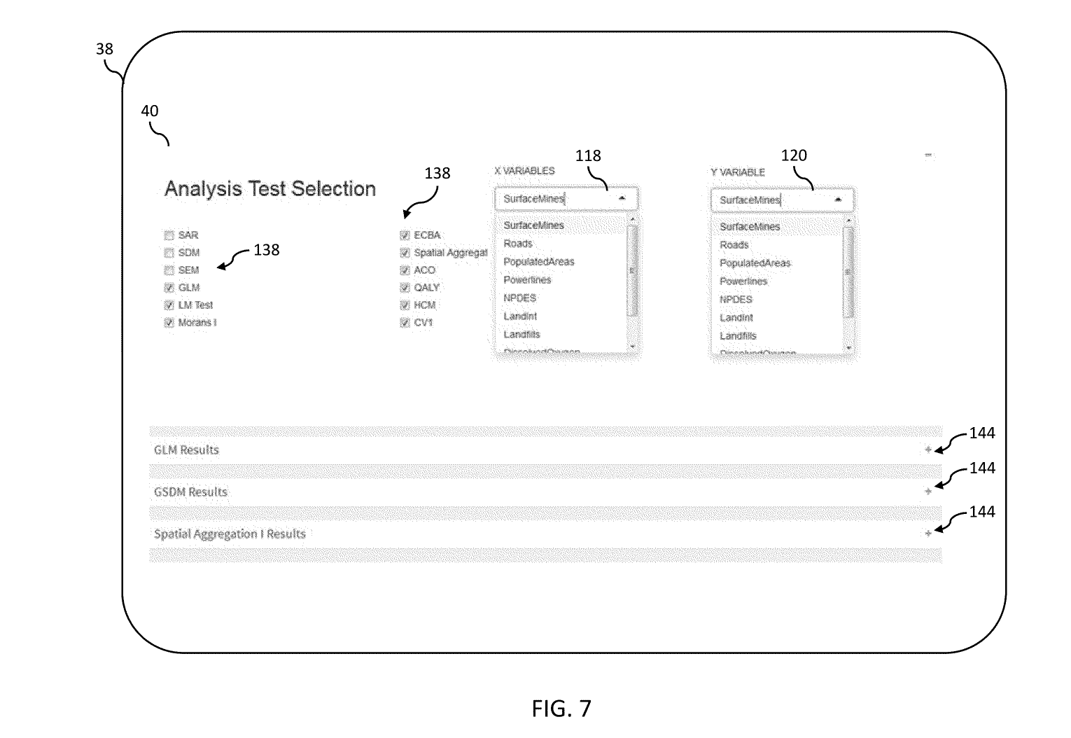

Alternatively or additionally, the test selection controls 138 can be configured to allow the user to manually edit the algorithms included with the preferred group 136. In some embodiments, the preferred group 136 can be populated automatically, and the test selection controls 138 can indicate the members of the preferred group. For example, each of the test selection controls 138 can comprise a description of the algorithm that is provided adjacent to a radio button. The radio button of the test selection controls 138 can be encoded to indicate whether the algorithm is included in the preferred group 136. The radio button can receive input to selectively include and exclude the algorithm from the preferred group 136. It is noted that, while FIG. 7 depicts the test selection control 138 as comprising a radio button, the test selection control 138 can comprise any object configured to receive input to include and exclude the analysis algorithm from the preferred group 136.

The method 100 can comprise a process 140 for analyzing the data using the preferred group 136 of the set of analysis algorithms 134. Specifically, the analysis engine 44 can transform the dataset using each of the analysis algorithms of the preferred group 136 of the set of analysis algorithms 134. When the preferred group 136 comprises multiple analysis algorithms, the dataset can be analyzed multiple times automatically. For example, each analysis algorithm of the preferred group 136 can be processed in parallel, sequentially, or a combination thereof. In some embodiments, the user interface 40 can comprise the variable control 118 and the dependent variable control 120. The variable control 118 and the dependent variable control 120 can receive input to select the variables for that are analyzed at process 140.

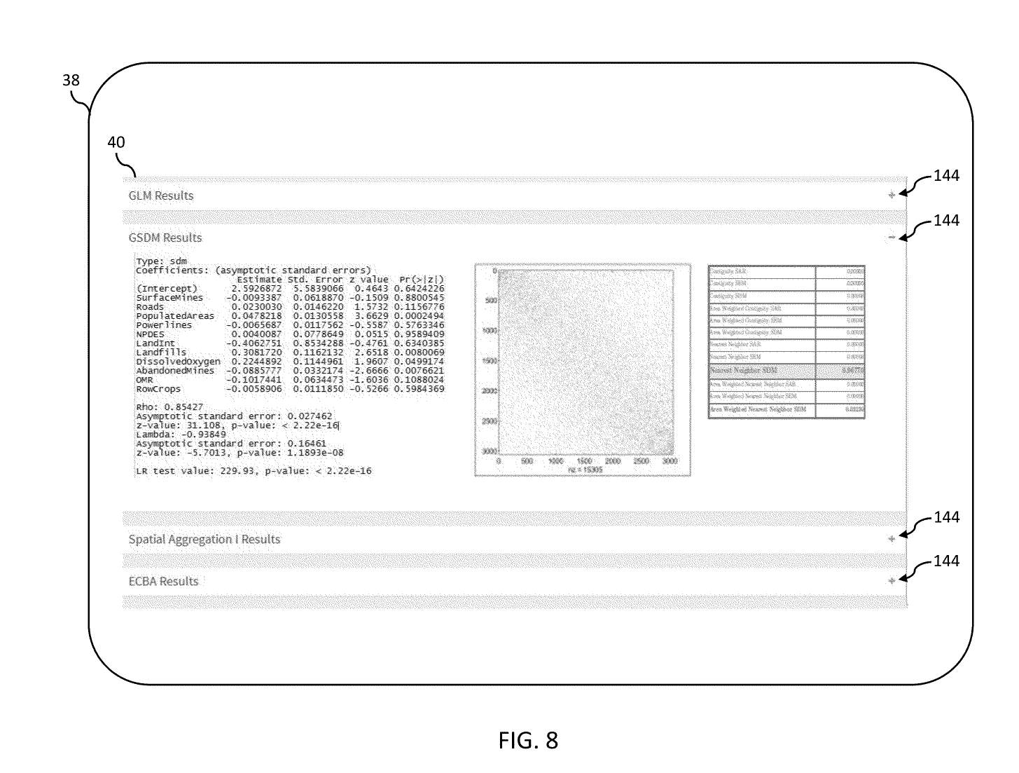

Referring collectively to FIGS. 1, 2, 6, and 8, the method 100 can comprise a process 142 for validating the analysis of the dataset. At process 142, after algorithms of the preferred group 136 evaluate the dataset, a validation object 144 can be provided by the user interface 40 for each algorithm. In some embodiments, the validation object 144 can be configured to minimize and maximize upon receiving input. When the validation object 144 is maximized, the validation object 144 can provide results of posterior testing indicative of the fit between the dataset and algorithm. For example, FIG. 8 depicts resultant data of a Gibbs Sampled Spatial Durbin Model (GSDM), where the posterior testing results show that the best model for the data is the SDM model. In some embodiments, the testing and outputs can dynamically update in response to changes in the variables, the preferred group 136, or both. Accordingly, process 140 and process 142 can be performed multiple times by manipulating any of the variable control 118, the dependent variable control 120, and test selection control 138.

Referring collectively to FIGS. 2, 6, and 9, the method 100 can comprise a process 146 for performing sensitivity analysis on the dataset. At process 146, after the analysis has been validated, the validated analysis of the dataset can undergo sensitivity analysis. In some embodiments, the sensitivity analysis tests can be performed using algorithms of the preferred group 136. The sensitivity analysis can evaluate the effect of incremental changes to significant parameters of the algorithms. For example, a sensitivity analysis object 148 can be provided by the user interface 40 for each algorithm. When the sensitivity analysis object 148 is maximized, the sensitivity analysis object 148 can provide a summary object 150 that displays the results of algorithm for the analyzed variables.

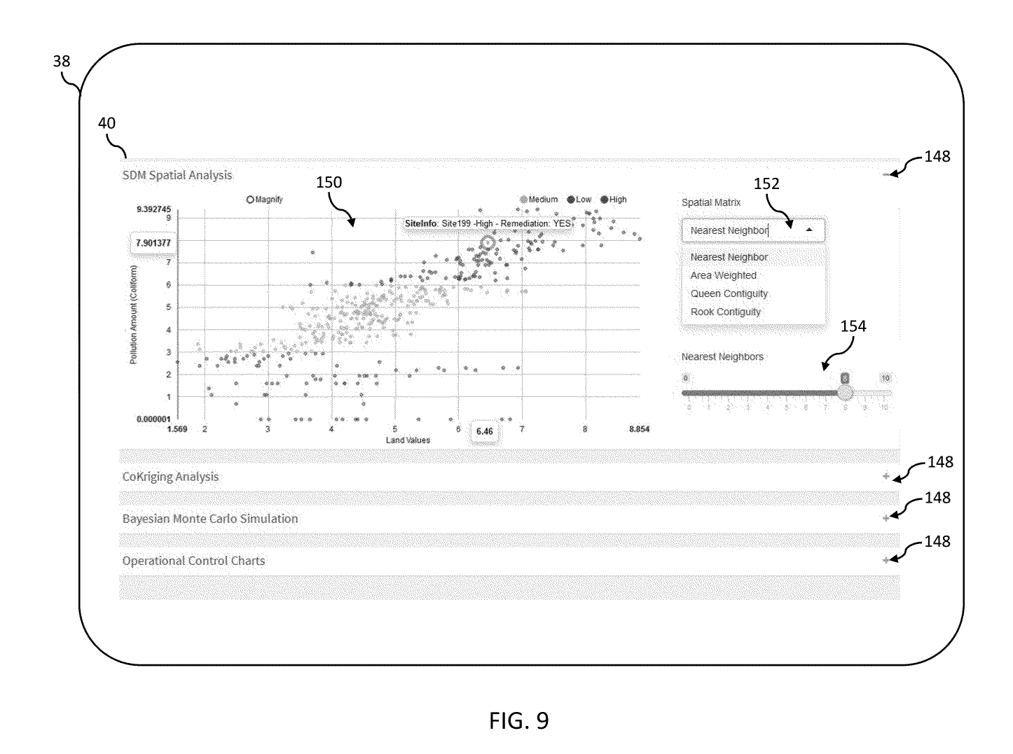

The sensitivity analysis object 148 can be configured to dynamically adjust the results provided in the summary object 150 to changes to parameters of the algorithm. In some embodiments, the sensitivity analysis object 148 can comprise a parameter selection control 152 for selecting parameters of the algorithm and a parameter adjustment control 154 for adjusting a selected parameter. In the embodiment depicted in FIG. 9, the parameter selection control 152 can be provided as a drop down box and the parameter adjustment control 154 can be provided as slider. More specifically in the depicted embodiment, the parameter selection control 152 can be manipulated to select the nearest neighbor parameter of an SDM Spatial Analysis. Accordingly, the parameter adjustment control 154 can be adjusted to cause the summary object 150 update in response to nearest neighbor changes. For example, if the parameter adjustment control 154 is changed from eight to four, the contiguity and spatial relevance of the data can be changed automatically (i.e., less data points considered neighbors, which can influence the overall remediation profile) to change the results of the analysis. Accordingly, at process 146, the sensitivity analysis can dynamically adjust the results to conform to the selected options. In some embodiments, process 116 and process 132 can be repeated. For example, the user interface 40 can be configured to allow the repeat the data inquiry and data analysis. Accordingly, the method 100 can perform multiple iterations until the sensitivity analysis indicates that the appropriate algorithms are selected for the preferred group 136 of the set of algorithms 134.

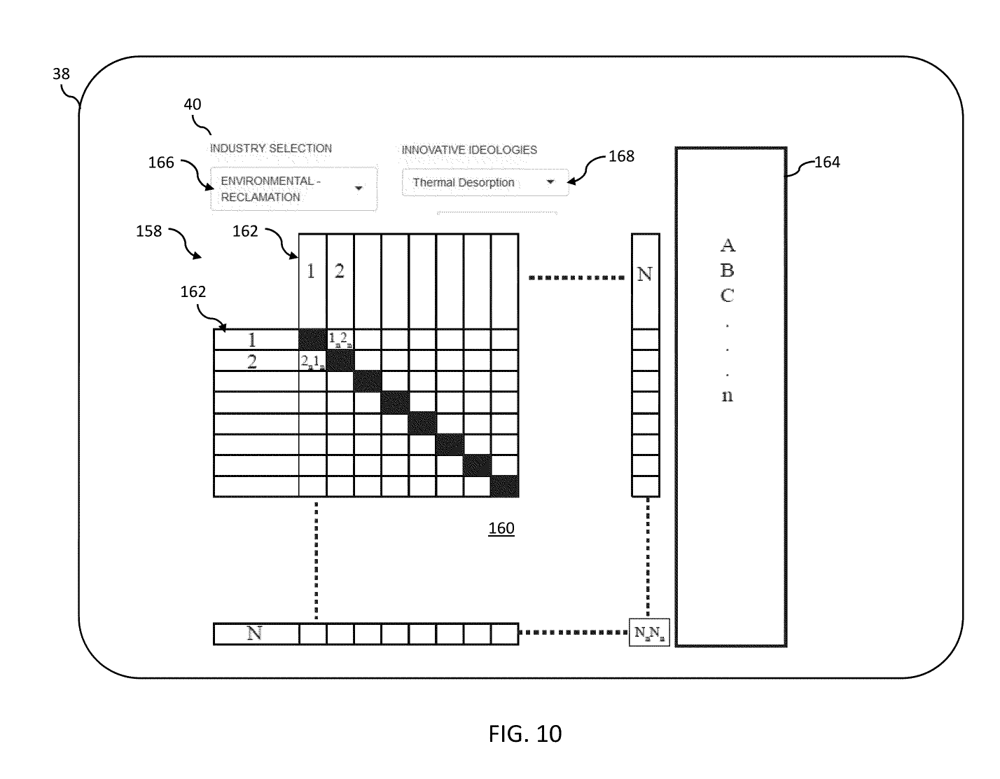

Referring collectively to FIGS. 2 and 10, the method 100 can comprise a process 156 for performing continuous improvement analysis on the dataset. Once the resultant analysis data is acceptable, the resultant analysis data can be imported into a continuous improvement matrix 158. Alternatively or additionally, resultant analysis data can be printed or exported to various data types such as, for example, .jpg, .csv, .txt, or the like. The continuous improvement matrix 158 can be a grid system that visually depicts a solution key 160 that compares variables of significance 162. Specifically, each of the variables of significance 162 can be arranged in the rows and columns of the continuous improvement matrix 158 and aligned with the solution key 160, such that each cell of the solution key 160 corresponds to a comparison of two of the variables of significance 162. For example, the cell at the second row and first column of the solution key 160 can correspond to a comparison of a second variable of the variables of significance 162 to a first variable of the variables of significance 162. The variables of significance can be selected via the user interface 40 with a control such as, for example, a dropdown box, radial buttons, or another selection method.

The solution key 160 can be encoded to correspond with similarity scoring of the variables of significance 162 with respect to innovative ideologies 164. The innovative ideologies 164 can correspond to process solutions indicative of a present and/or future best practice in an industry, which can be referenced from current research and projects. Accordingly, each variable of significance 164 can be scored for similarity with respect to each of innovative ideologies 164. Thus, when it is not possible to change one of the variables of significance 164, suitable alternatives can be identified in the variables of significance 164 based upon similarity of the solution key 160. In some embodiments, the innovative ideologies 164 can be arranged according to an industry specific framework such as, for example, mining, oil/natural gas, environmental reclamation, environmental conservation, manufacturing, forestry, government, and other industry QHSE related processes. Accordingly, an industry selection control 166 can be provided on the user interface 40 to receive input indicative of a selection of an industry. Once the significant variables 162 and the industry selection are made, a series of associated innovative ideologies 164 can be identified. The user interface 40 can further comprise a ideology control 168 to receive input indicative of a selection of one of the associated innovative ideologies 164. Once one of the innovative ideologies 164 is selected, the solution key 160 can be dynamically updated to show similarity scoring of the variables of significance 162 with respect to the selected one of the innovative ideologies 164.

The continuous improvement matrix 158 can be zoomable and searchable using the user interface 40. Additionally, each of the cells of the solution key 160 can be configured as a control object that denotes various information when selected such as, for example, how related one site is to another, or how one process is related to another. For example, when a user hovers over a cell, the corresponding variables of significance 162 and a similarity score can be displayed as well as the significant factors attributing to the similarity score. Accordingly, the user interface 40 can provide a user with information that can support decisions regarding which solution of the innovative ideologies 164 is applicable to other sites or processes.

It should now be understood that the embodiments described herein can be used by commercial and public entities to achieve sustainable growth and increase the economic profit, social responsibility, and environmental protection. For example, a natural resource entity can utilize the embodiments described herein to assess data from multiple geographic locations to assess feasibility through the entire lifecycle of the project. The analysis of the myriad of data types and sources involved with a natural resource undertaking can quickly become overwhelming given existing systems and technologies. The data sources can include: capital cost data, fleet and logistical information to and from the site, production flow information, health and safety engineering controls such as monitors, community survey information, legal acquisition data, pollution flows, cleanup expenditures, defense expenditures, pollution decay and absorption rates, ecological data, soil data, geological assay data, drill hole data, and the like.

Embodiments of the present disclosure can be used to significantly reduce the work effort involved in data collection, analysis, integration, visualization, and interpretation of these data sources. Some embodiments provide flexibility and dynamic processes necessary to improve upon known technologies related to QHSE processes. In addition to the more efficient and robust processing of the analysis engine, the continuous improvement matrix can create and improve the ability of the natural resource entity to repeat best practices (e.g., improved extraction rates under certain factors in the dataset), make decisions (e.g., daily workforce needs, mergers and acquisitions of similar territories or companies, and transportation infrastructures associated with a project), and adapt QHSE processes for multiple sites, improving upon project transitional phases (e.g., conceptual planning to breaking ground to peak production phases to closeout and reclamation). Moreover, significant factors caused by negative externalities and delayed decision making processes can be reduced. Examples of negative externalities and delayed decision making processes can include, for example, climate change contribution, local aesthetic damages, additional social and environmental pressures and the like. In addition to natural resource commercial entities, the embodiments of the present disclosure can be used throughout a project lifecycle, or can be used by public entities to evaluate project factors that influence the welfare of local communities and ecosystems.

As provided herein, large QHSE datasets can be dynamically evaluated using an iterative framework. The dynamic and iterative framework can be used to identify effective management action, and reduce effort in coming to sustainable conclusions. Additionally, the framework can increase flexibility, utility, and robustness of analytical models by supplementing an incomplete understanding of analytical models. Moreover, the dynamic and iterative framework can reduce the amount of effort required to modify analysis. For example, data can be modified without needing to adjust the analytical algorithms. Moreover, the analytical algorithms can be changed without requiring recoding or reloading QHSE data. Furthermore, the dynamic and iterative framework evaluates the effectiveness of multiple analytical models to reduce uncertainty in the results. For at least the reasons provided herein, the dynamic and iterative framework can facilitate hybrid (machine+user) learning by conducting multiple analytical experiments that provide information about how ecosystems may respond to alternative management actions.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A computer implemented method for evaluating Quality, Health, Safety, and Environment (QHSE) data, the method comprising:
providing a user interface upon a display communicatively coupled to one or more processors;
receiving category selections with a plurality of category controls of the user interface, wherein the category selections categorize the QHSE data;
identifying, automatically with the one or more processors, a preferred group of analysis algorithms from a set of analysis algorithms based upon the category selections;
analyzing, automatically with the one or more processors, the QHSE data with each of the preferred group of analysis algorithms;
performing, automatically with the one or more processors, posterior testing on each of the preferred group of analysis algorithms; and
providing, automatically with the one or more processors, a validation object for each of the preferred group of analysis algorithms with the user interface, wherein the validation object selectively provides results of the posterior testing indicative of a fit between the QHSE data and one of the preferred group of analysis algorithms.

2. The method of claim 1, comprising:
providing, automatically with the one or more processors, test selection controls with the user interface, wherein the test selection controls indicate the preferred group of analysis algorithms;
receiving input to selectively include members of the preferred group of analysis algorithms, automatically with the one or more processors, via the test selection controls; and
editing the preferred group of analysis in response to the input to selectively include the members of the preferred group of analysis algorithms.

3. The method of claim 2, comprising:
analyzing, automatically with the one or more processors, the QHSE data with each of the preferred group of analysis algorithms in response to the input to selectively include the members of the preferred group of analysis algorithms.

4. The method of claim 1, comprising:
providing, automatically with the one or more processors, a sensitivity analysis object for each of the preferred group of analysis algorithms with the user interface, wherein the sensitivity object comprises a summary object that displays results of a corresponding algorithm of the preferred group of analysis and a parameter adjustment control;
receiving a parameter change with the parameter adjustment control; and
updating, automatically with the one or more processors, the results of the corresponding algorithm and the summary object in response to the parameter change

5. The method of claim 1, comprising:
importing results of the QHSE data analyzed by the preferred group of analysis algorithms into a continuous improvement matrix of the user interface, wherein the continuous improvement matrix visually depicts a solution key that scores similarity of variables of significance of the results of the corresponding algorithm with respect to an innovative ideology.

6. The method of claim 1, comprising:
processing, automatically with the one or more processors, the QHSE data with one or more aggregation and formatting tests.

7. The method of claim 6, wherein the one or more aggregation and formatting tests comprises normalization, parsing, clustering, dependency, dimensionality algorithms, or a combination thereof.

8. The method of claim 1, the QHSE data is categorized by the category selections to distinguish between quantitative data and qualitative data.

9. The method of claim 8, wherein the preferred group of analysis algorithms comprises Frequentist methodologies, Bayesian methodologies, Decision/Game Theory methodologies, or a combination thereof, and wherein the quantitative data of the QHSE data is analyzed with the Frequentist methodologies, the Bayesian methodologies, the Decision/Game Theory methodologies, or the combination thereof.

10. The method of claim 8, wherein the preferred group of analysis algorithms comprises Ranking methodologies, and wherein the qualitative data of the QHSE data is analyzed with the Ranking methodologies.

11. The method of claim 1, wherein the QHSE data is categorized by the category selections to distinguish between discrete data and continuous data.

12. The method of claim 1, wherein the QHSE data is categorized by the category selections to distinguish between spatial data and non-spatial data.

13. The method of claim 1, wherein the QHSE data is categorized by the category selections to distinguish between low uncertainly data and high uncertainty data.

14. The method of claim 1, wherein the QHSE data is analyzed by the preferred group of analysis algorithms in parallel.

15. The method of claim 1, wherein the QHSE data is analyzed by the preferred group of analysis algorithms sequentially.

16. The method of claim 1, the display is communicatively coupled to a server comprising at least one processor of the one or more processors, and wherein the QHSE data is analyzed by the preferred group of analysis algorithms using the at least one processor of the server.

17. A computer implemented method for evaluating Quality, Health, Safety, and Environment (QHSE) data, the method comprising:
providing a user interface upon a display communicatively coupled to one or more processors;
analyzing, automatically with the one or more processors, the QHSE data with a plurality of analysis algorithms;
providing, automatically with the one or more processors, a sensitivity analysis object for each of the analysis algorithms with the user interface, wherein the sensitivity object comprises a summary object that displays results of a corresponding analysis algorithm of the analysis algorithms and a parameter adjustment control;
receiving a parameter change with the parameter adjustment control;
updating, automatically with the one or more processors, the results of the corresponding analysis algorithm and the summary object in response to the parameter change; and
importing the results of the corresponding analysis algorithm into a continuous improvement matrix of the user interface, wherein the continuous improvement matrix visually depicts a solution key that scores similarity of variables of significance of the results of the corresponding algorithm with respect to an innovative ideology.

18. The method of claim 17, comprising:
receiving category selections with a plurality of category controls of the user interface, wherein the category selections categorize the QHSE data; and
identifying, automatically with the one or more processors, the analysis algorithms from a set of analysis algorithms based upon the category selections.

19. The method of claim 17, comprising:
providing, automatically with the one or more processors, test selection controls with the user interface, wherein the test selection controls indicate the analysis algorithms;
receiving input to selectively include members of the analysis algorithms, automatically with the one or more processors, via the test selection controls; and
editing the members of analysis algorithms in response to the input to selectively include the members of the preferred group of analysis algorithms.

20. The method of claim 17, comprising:
performing, automatically with the one or more processors, posterior testing on each of the analysis algorithms; and
providing, automatically with the one or more processors, a validation object for each of the analysis algorithms with the user interface, wherein the validation object selectively provides results of the posterior testing indicative of a fit between the QHSE data and one of the analysis algorithms.
